(19) United States
(12) Patent Application Publication
(10) Pub. No.: US 2022/0287242 A1
(43) Pub. Date: Sep. 15, 2022

(54) ROTARY DRUM TRIMMER WITH DYNAMAIC SHEAR BAND

(71) Applicant: ETEROS TECHNOLOGIES USA, INC., Surrey (CA)

(72) Inventors: Donald Mosman, Nevada City, CA (US); Dana Mosman, Boulder, CO (US); Ángel Ramon Torrado Perez, San Diego, CA (US)

(21) Appl. No.: 17/686,078

(22) Filed: Mar. 3, 2022

Related U.S. Application Data
(60) Provisional application No. 63/159,150, filed on Mar. 10, 2021.

(51) Int. Cl. A01G 3/00

(52) U.S. Cl. CPC A01G 3/002

(57) ABSTRACT

A rotary drum trimmer device with one or more dynamic shear bands. The trimming device receives plant material through a hollow interior of a generally cylindrical drum having a plurality of perforations extending through its sidewall. The perforated drum rotates to tumble plant material within its interior thereby exposing portions of the plant material through perforations in the drum sidewall. Disposed against an outside surface of the rotating perforated drum are one or more shear bands. Rotary moment of the drum relative to the shear bans(s) severs plant material extending through both elements. The shear band is configured to move (e.g., reciprocally) relative to the perforated drum while the drum rotates to improve trimming.

### CROSS REFERENCE

This application claims the benefit of the filing date of U.S. Provisional Application No. 63/159,150 having a filing date of Mar. 10, 2021, the entire contents of which is incorporated herein by reference.

### FIELD

The present disclosure relates to rotary trimmers for trimming plant material. More specifically, the present disclosure relates to a rotary trimmer having a perforated rotating drum that rotates relative to one or more shear bands disposed about a portion of an outside surface of the drum. A resilient connection of the shear band(s) allows the band to move relative to the rotating drum, which provides an improved shearing action.

### BACKGROUND

Post-harvest processing is commonly performed to separate or fractionate plant materials. In some instances, post-harvest processing of plant material such as flowers, buds and leaves, entails removal of, for example, an undesirable portion of the plant material from a desirable portion of the plant material. Various methods are known for post-processing or trimming plant materials for a variety of purposes. One type of machine for trimming plant material utilizes a perforated rotating drum (e.g., cylindrical drum) to tumble plant materials while those plant materials passes through a hollow interior of the rotating drum. One or more cutting elements (e.g., stationary and/or rotating) adjacent to an outside surface of the drum cut portions of the plant materials extending through the perforations/apertures of the drum while the drum is rotating.

### SUMMARY

Provided herein is a trimming device for trimming plant material. The trimming device is configured to receive plant material through a hollow interior of a generally cylindrical drum having a plurality of perforations extending through its sidewall. In operation, the drum (e.g., perforated drum) rotates to tumble plant material within its interior thereby exposing portions of the plant material through perforations in the drum sidewall. Disposed against an outside surface of the rotating perforated drum are one or more shear elements. Such shear elements extend around a portion (e.g., lower portion) of the drum and include openings or apertures through which portions of the plant material extending through perforations in the drum sidewall may pass. Rotary moment of the drum relative to the shear element severs plant material extending through both elements. The shear element may be formed from a thin sheet of metal, a fabric having sufficient rigidity (e.g., a net, screen, etc.), plastic/polymer or any other element having a plurality of openings or apertures through which leaves or other plant material extending through the perforations in the drum may extend. Alternatively, the shear element may be formed of a plurality of interconnected and spaced blades. For instance, such blades may be elongated strips (e.g., metal) connected to straps where plant material may extend between openings between adjacent blades. The shear element may have any configuration that allows the shear element to be tensioned about a portion of the drum while permitting plant matter to extend through a portion of the shear element. Any such shear element may be referred to generally as a “shear band”. Aspects of the presented disclosure are directed to a trimmer system that imparts a reciprocal or oscillatory movement to the shear band to improve trimmer efficiency. Such reciprocal or oscillatory movement may be passively imparted via rotation of the drum or may be actively imparted by an actuator that physically displaces the shear band.

### BRIEF DESCRIPTION OF THE DRAWINGS

FIG. 1 is a perspective view of an exemplary prior art rotary drum plant processing device.

FIGS. 2A-2B show first and second views of a prior art rotary plant trimmer.

FIGS. 3A and 3B illustrate front and rear views a rotary plant trimmer that utilizes a shear band in accordance with the present disclosure.

FIG. 4 illustrates a perspective view of a perforated drum.

FIG. 5 illustrates a shear band.

FIG. 6A illustrates a partial cross-sectional view of FIG. 3A illustrating the perforated drum positioned above shear bands.

FIG. 6B illustrates the partial cross-sectional view of FIG. 6A with a section of the perforated drum removed.

FIG. 6C illustrates a cross-sectional view of FIG. 3A.

FIGS. 7A-7C illustrate slip-stick motion of the shear band.

FIGS. 8A and 8B illustrate another embodiment of a shear band trimming system.

FIGS. 9A and 9B illustrate another embodiment of a shear band trimming system.

FIGS. 10A and 10B illustrate another embodiment of a shear band trimming system.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

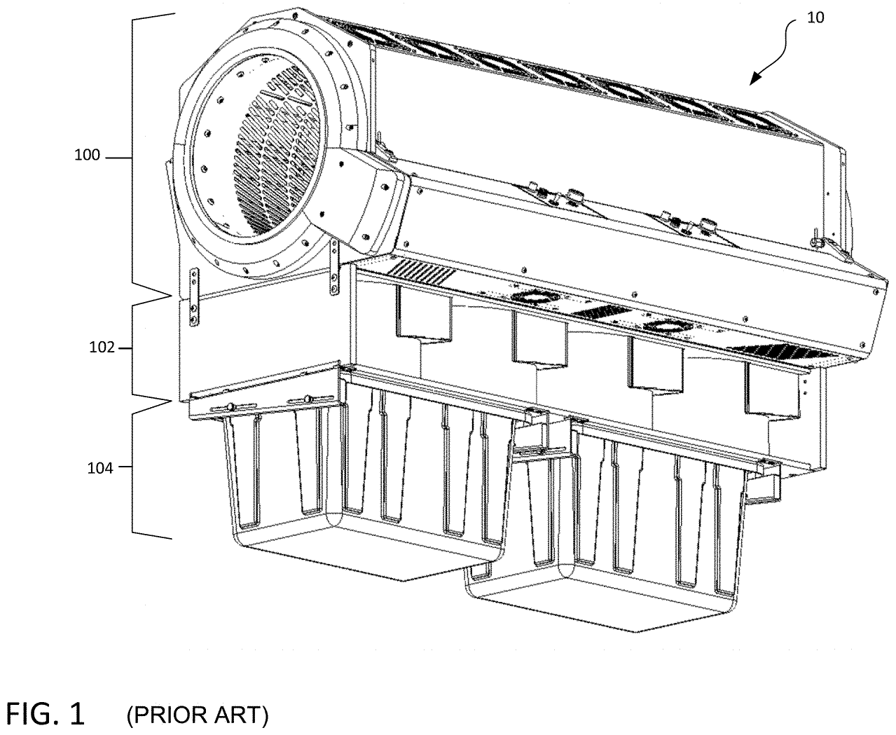

FIG. 1 illustrates a perspective view of an exemplary rotary trimming system. The rotary trimming system 10 separates leaves from harvested plant materials, including ingestible or otherwise consumable plant materials. The remaining portion (e.g., trimmed portion) of the harvested plant material may be a flowering or body portion of the plant (e.g., bud) from which leaves may be separated. Separated leaves and/or trimmed portions of the plant material may be used in a variety of applications. The illustrated plant trimming system 10 includes a rotary trimmer assembly 100, a separator assembly 102 and a collection assembly 104.

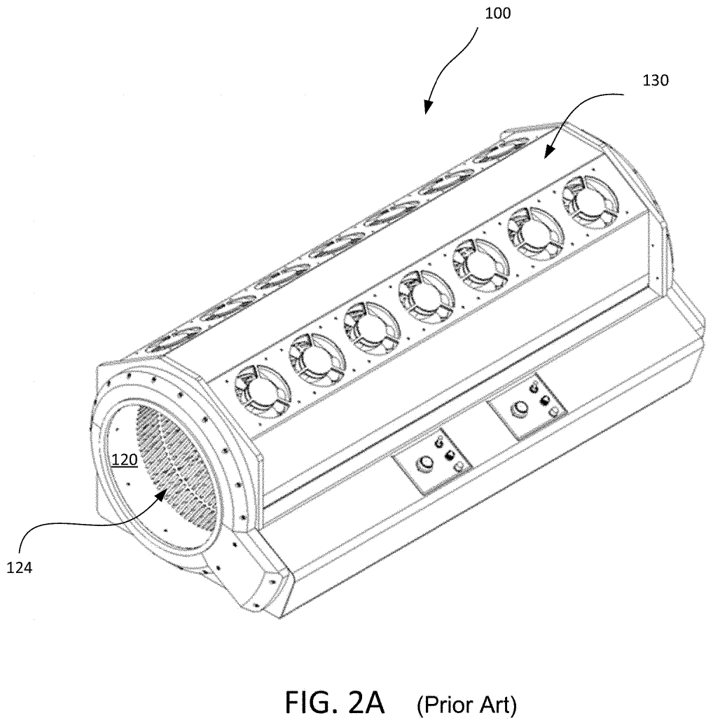

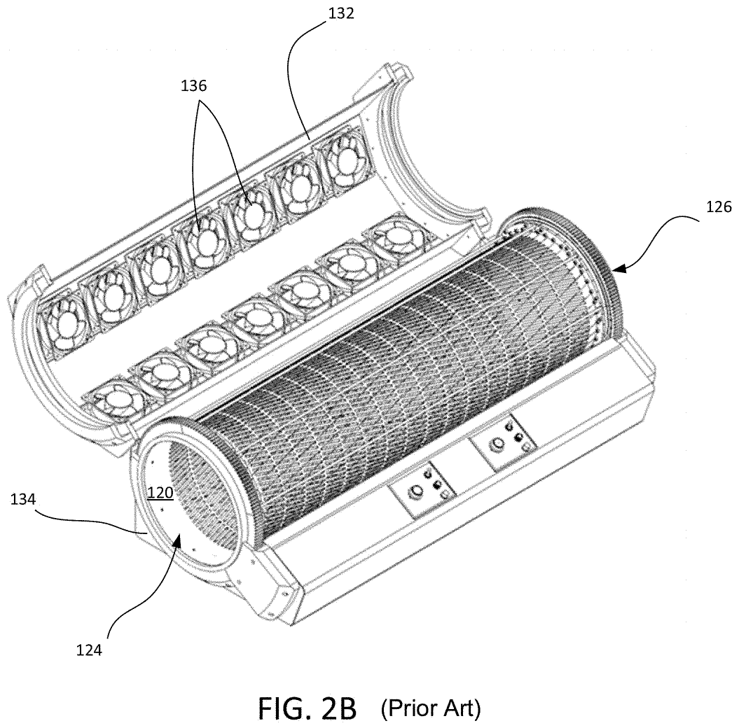

FIGS. 2A and 2B illustrate the exemplary rotary trimmer 100 as removed from the remainder of the system of FIG. 1. In an embodiment, the rotary trimmer 100 separates leaves of plant material by severing leaves (or other plant materials) between two components. In the illustrated embodiment, a rotating perforated drum 120 receives plant materials containing, for example, leaves and a flowering portion or bud within its hollow interior. The plant materials may be received at a first end 126 of the rotary trimmer and migrate through the trimmer to a second end 124 during rotation of the drum. Rotation of the drum 120 also causes leaves of the plant material to extend through perforations in the sidewall of the rotating drum 120. In some embodiments, a second rotating cutting element, such as a helical blade (not shown) may be positioned to engage an outside surface of the drum 120. Rotation of the cutting element, typically in a second direction opposite the first direction, causes the drum and cutting element to exert opposing forces on portions of the leaves or other material extending through perforations in the drum 120. This severs the leaves between the drum 120 and the cutting element abutting an outside surface of the drum. In some embodiments, the drum and cutting element may rotate in the same direction at different speeds. In any embodiment, the rotation of the drum relative to the cutting element allows the plant trimmer to sever leaves disposed between the drum and cutting element thereby separating a portion of the leaf from the plant material within the interior of the drum.

In the illustrated embodiment, the rotary drum 120 is disposed within a housing 130 that surrounds upper and side portions of the drum 120 and cutting devices (not shown). In the illustrated embodiment, the housing 130 includes an upper shroud 132 that extends over the top half of the drum 120 and engages a lower shroud 134 that extends along the sides of the drum 120. The upper shroud 132 may further include a plurality of fans 136 that are configured to blow air into the device. That is, such fans 136 may provide a positive airflow into the interior of the trimmer and drum during operation. A drum drive motor (not shown) rotates the perforated drum 120 about its longitudinal axis. The plant trimmer may include one or more electric motors that impart a rotation to the drum 120 and, if utilized, the rotary shearing device. Exemplary rotary drum and rotary shearing type trimmers are set forth in co-owned U.S. Pat. No. 8,757,524 and co-owned U.S. Patent Publication No. 2019/0297782, the entire contents of which are incorporated herein by reference.

The rotary trimming system illustrated in FIGS. 1, 2A and 2B is most commonly utilized for wet trimming of very moist plant matter and/or in applications where fluid is sprayed into the drum during operation. Such wet trimming systems typically utilize a rotary shearing mechanism (e.g., a rotating helical blade) to sever plant material extending through the slots of the perforated drum. In dry trimming rotary drum systems, a stationary shear band may be positioned about a portion of an outside surface of the rotating drum. In such an arrangement, an outside surface of the rotating drum rotates relative to an inside surface of stationary shear band, which may be tensioned around a lower portion of the drum. The shear band is typically a thin sheet (e.g., metal, nylon, etc.) having a plurality of slots or apertures. Plant material extending through perforations or slots in the rotating drum may also extend through the slots or perforations in the shear band. Rotation of the drum severs such plant material between the edges of the moving slots in the drum and the edges of the slots in the shear band tensioned about an outside surface of the drum.

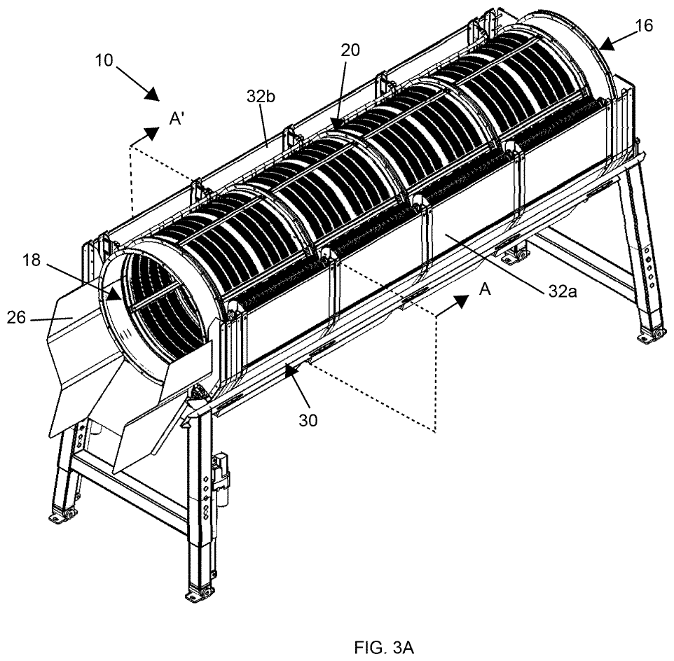

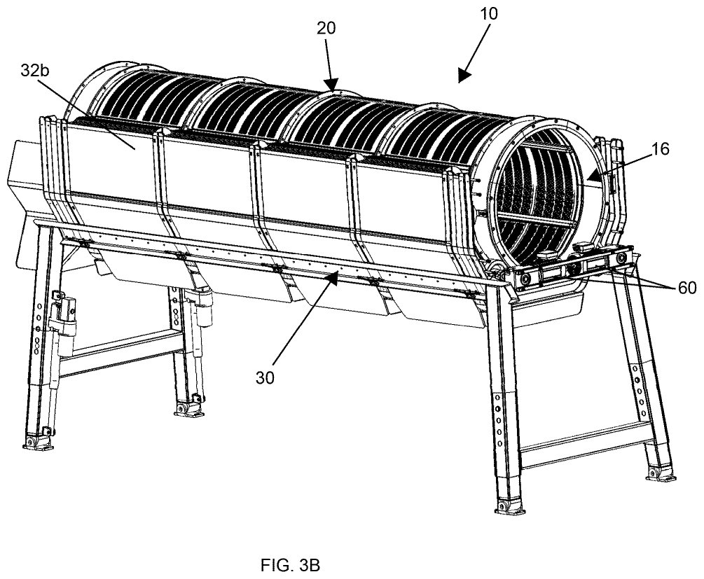

FIGS. 3A and 3B illustrate an embodiment of a rotary drum trimmer system 10 utilizing one or more dynamic shear bands to trim plant material passing through the interior of a rotating drum. The trimmer system 10 includes a perforated drum 20 configured to rotate about its longitudinal axis, when driven by one or more drum drive motors 60. In the illustrated embodiment, two motors 60 are configured to rotate first and second drive rollers 62 (only one shown) to impart rotation to the drum 20. Additional rollers may be disposed along the length of the drum to support the drum and allow the drum to rotate relative to a frame/housing 30 of the trimmer system 10. In the illustrated embodiment, the drum 20 extends along a longitudinal axis from a first open inlet end 16 to a second open outlet end 18 forming a hollow cylindrical sidewall having a lower portion disposed within the housing 30. As illustrated, the housing 30 includes first and second sidewalls 32a, 32b (hereafter 32 unless specifically referenced), which extend along the length of the cylindrical drum 20. In an embodiment, material trimmed by the drum and shear band(s) falls into the interior of the housing or through a bottom of the housing for subsequent collection. Other arrangements are possible. The inlet end 16 of the drum 20 may receive plant material from a chute or conveyor. In any arrangement, plant material feeds into the hollow interior of the drum 20 through the inlet end 16 and migrates to the outlet end 18 of the drum 20 while the drum rotates. The rotation of the drum 20 tumbles the plant material within the interior of the drum 20 exposing portions of the plant material through perforations in the sidewall of the drum. The portions of the plant material extending through the perforation in the drum may be trimmed by the one or more shear bands disposed about a lower portion of the drum. The trimmer system may also include an outlet chute 26 attached to an outlet end 18 of the drum 20.

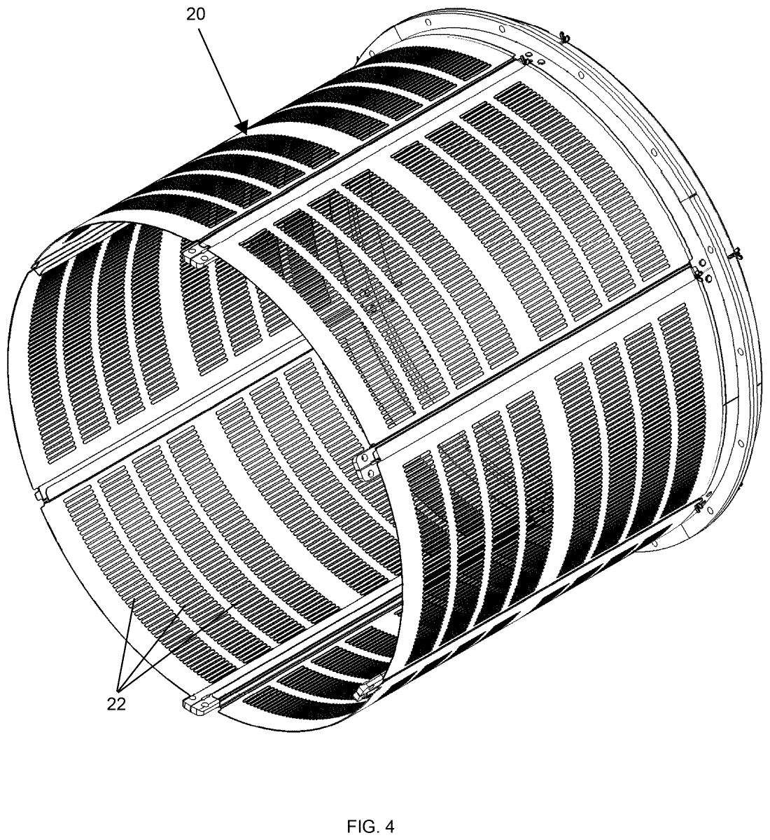

FIG. 4 illustrates a perspective view of one section of the drum 20. In the illustrated embodiment, the drum 20 is formed of four separate sections attached end-to-end. However, this is not a requirement. It will be appreciated that the drum may be formed as a single section, additional sections or fewer sections. The single section of the drum 20 is illustrated for purposes of discussion and not by way of limitation. Further, in the illustrated embodiment, the section of the drum 20 is formed from six radial sections connected together to collectively form an annular sidewall. Other configurations are possible. In an embodiment, a plurality of slots 22 (e.g., perforations) are disposed in a repeating pattern through the sidewall of the drum 20. These slots form apertures the extend through the sidewall from its inner surface to its outer surface. The plurality of slots 22 may be disposed in multiple columns extending along a longitudinal length of the drum 10 where each individual column of slots extends around a periphery of the drum 20. As illustrated, the slots 22 are positioned about a majority of the peripheral surface of the drum and collectively define a perforated surface of the drum. In the present embodiment, the perforated surface is formed from a plurality of equally sized, aligned generally rectangular slots. However, the perforations may be formed as circles, ovals or any polygonal or non-polygonal shape. Variation is possible.

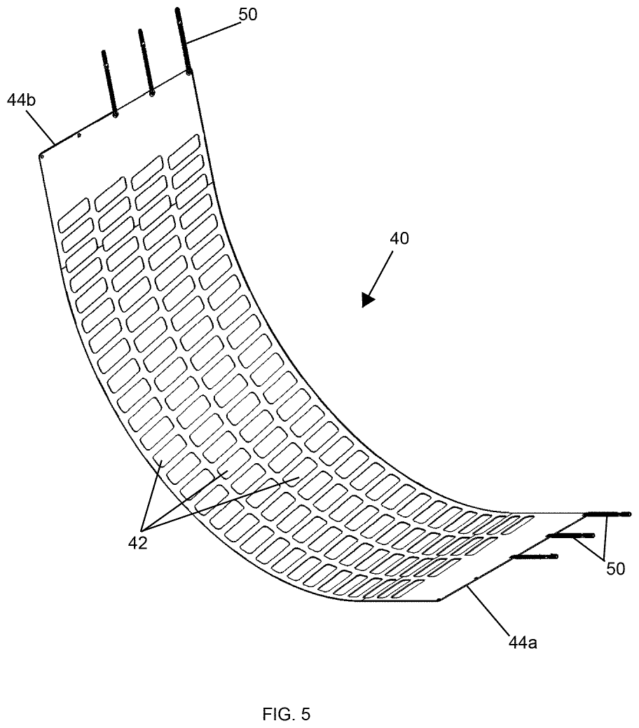

FIG. 5 illustrated one embodiment of a shear band 40 that may be disposed about an outside portion of the rotating drum to trim material extending through perforations in the drum. In an embodiment, the shear band 40 is formed from a thin sheet material (e.g., metal, nylon, etc.) having a plurality of apertures 42 (e.g., a repeating pattern of apertures) formed through its surface. Generally, the sheet material forming the shear band is flexible to permit the shear band to conform about an outside surface of the drum. In the illustrated embodiment, the apertures in the shear band 40 are larger than the perforations or slots in the drum to better allow plant material extending through perforations in the drum to pass through the apertures in the shear band 40. In the present embodiment, the apertures 42 in the shear band 40 are formed of a plurality of equally sized, aligned generally trapezoidal slots. However, the apertures may be formed as rectangles, circles, ovals or any polygonal or non-polygonal shape. Variation is possible.

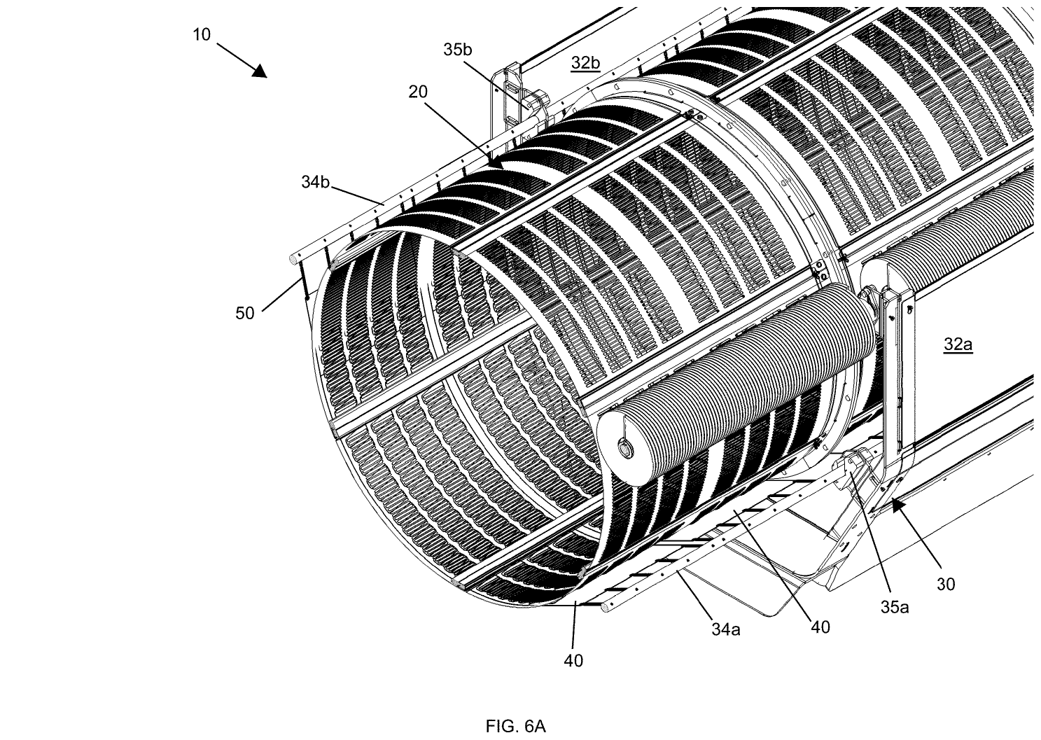

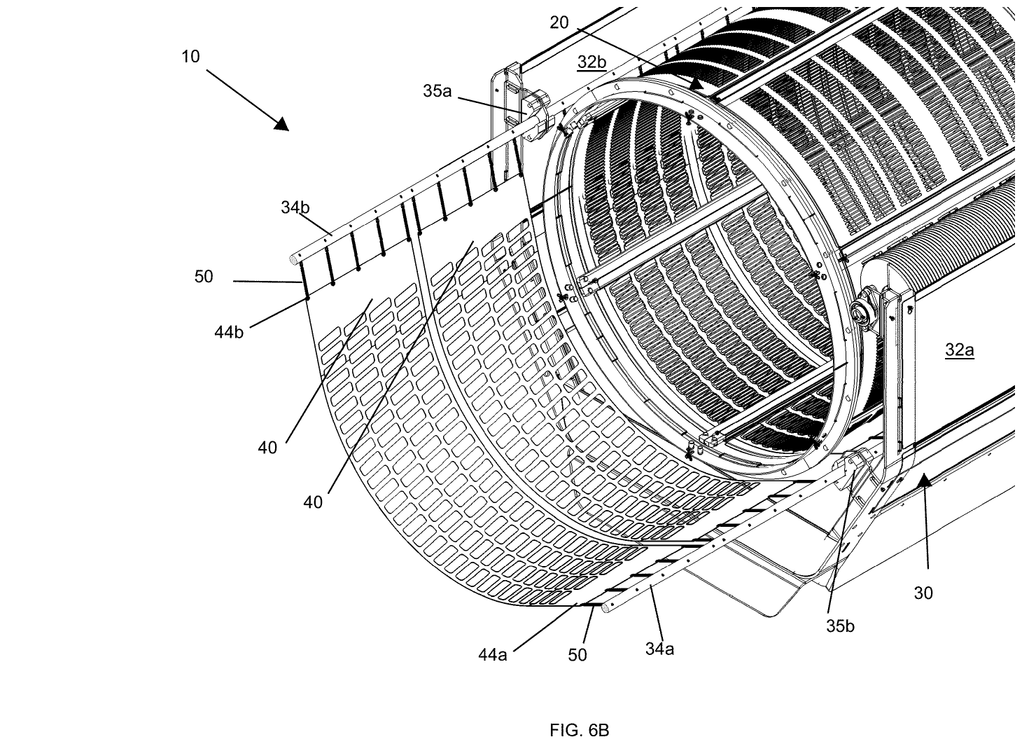

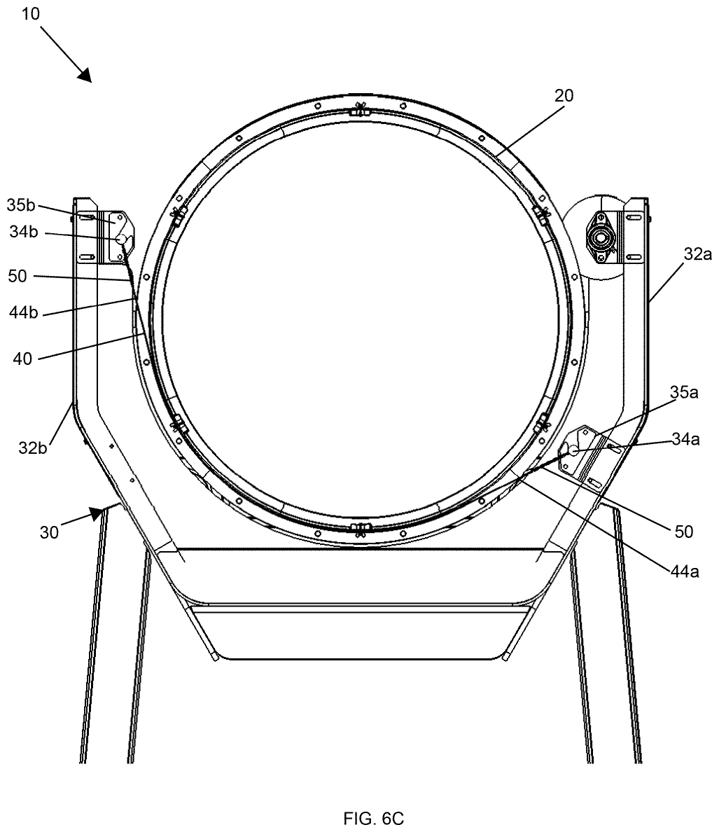

In the illustrated embodiment, the trimmer system 10 incorporates a plurality of shear bands 40 disposed around and against a portion of an outside surface of the drum 20. This is best illustrated in FIGS. 6A and 6B which show cross-sectional views taken along plane of A-A′ of FIG. 3A. For purposes of illustration, various shrouding and support frame elements are removed from the illustrations of FIGS. 6A and 6B. FIG. 6A illustrates a section of the rotary drum 10 disposed against first and second shear bands 40 while FIG. 6B illustrates the same view with the section of the rotary drum shown in FIG. 6A removed (e.g., for purposes of illustration). As shown, the shear bands 40 extend around an outside surface of the drum section. In the illustrated embodiment, each drum section has a first and a second shear bands tensioned about a portion of its outside surface. Further, each shear band 40 extending around a portion of its respective drum section is disposed over perforations or slots 22 extending through the drum 20. In the present embodiment, eight separate shear bands are disposed along the length of the rotary drum of the rotary trimmer system. Though illustrated as utilizing a plurality of individual shear bands, it will be appreciated that other shear band configurations (e.g., one shear band having a width/length that covers the longitudinal length of the drum) may be utilized. In any embodiment, the shear band(s) may be tensioned about an outside surface of the drum 20 to allow trimming plant material while the drum 20 rotates.

As illustrated in FIGS. 6A-6C, each shear band 40 has a first end 44a attached to a first sidewall 32a of the frame or housing 30 and a second end 44b attached to a second sidewall 32b of the frame or housing 30. The body of the shear band 40 between the first and second ends passes below and around a lower portion of the rotary drum 20. In this regard, an outside surface of the drum 20 rests against an upper surface of the shear band 40 and, in operation, rotates relative to the upper surface of the shear band 40. As briefly discussed above, plant material passing through the slots 22 in the drum 20 and the apertures 42 in the shear band are sheared between the edges of the slots 22 and apertures 42 as the drum 20 rotates. To provide an adequate interface for shearing, the shear band 40 is typically tensioned. That is, one or more tensioning elements may be provided on one or both ends of the shear band 40 to pull the band to a desired tension around a portion of the outside surface of the drum.

Aspects of the present disclosure are based on the recognition that an improved shearing action between the drum and the shear band can be achieved by imparting movement to the shear band. More specifically, the present disclosure provides a shear band rotary trimmer system where the shear band 40 moves relative to the drum 20 in conjunction with rotation of the drum 20. In an embodiment, both ends of the shear band(s) are resiliently connected to the frame or housing of the trimmer system allowing rotation of the drum to impart movement to the shear band. Resilient connections at both ends of a shear band both tension the shear band around the rotary drum and allow the shear band to move in a slip-stick motion where the shear band reciprocates or oscillates relative to the outside surface of the drum, as further discussed below. In another embodiment, a vibration motor may be attached to the shear band to enhance movement of the band. In a further embodiment, one end of the shear band(s) may be resiliently connected to the frame or housing of the trimmer while the other end of the shear band(s) is connected to an actuator that imparts movement to the shear band(s).

FIGS. 5, 6A, 6B and 6C illustrate the resilient connections of the first and second ends 44a, 44b of the shear band 40 to the first and second sidewalls 32a, 32b, respectively, of the trimmer frame or housing 30. As illustrated each end 44a or 44b (hereafter 44 unless specifically referenced) attaches to its respective sidewall 32a or 32b (hereafter 32 unless specifically referenced) via one or more resilient elements 50 (e.g., an array of springs). As utilized herein, a resilient element may be any element (e.g., bias force element) that is able to recoil or spring back into its original shape after stretching or compressing (e.g., with minimal or no plastic deformation). The resilient element may be formed, without limitation, from elastic bands (e.g., polymeric materials such as natural or synthetic rubbers) or springs (e.g., metallic springs) to name a few. In the illustrated embodiment, the resilient elements 50 are coil springs. In an embodiment, each end of the shear band 40 attaches to a hanger bar 34a, 34b (hereafter 34 unless specifically referenced) disposed along and connected to an inside surface of the sidewalls 30. As illustrated, each end 44 of the shear band 40 connects to its respective hanger bar 30 via one or more resilient elements 50 (hereafter spring or springs 50). In the illustrated embodiment, an array of five springs 50 attaches each end of the shear band 40 to the hanger bars 34a, 34b. Each spring 50 may attach to its respective hanger bar 34 via an adjustable connector. In an embodiment, such an adjustable connector is a threaded element (e.g., bolt) that engaged a threaded aperture in the hanger bar. By adjusting the adjustable connectors individually, a desired deflection (e.g., stretch) may be imparted to each of the springs. Further, the brackets 35 connecting the hanger bars 34 may be adjustable (e.g., up or down; not shown) to provide adjustment (e.g., global adjustment) to all springs connected thereto.

In the illustrated embodiment, each hanger bar 34a, 34b connects to two adjacent shear bands 40. The hanger bars 34a, 34b are configured to engage upper and lower mounting brackets 35a, 35b. More specifically, first and second ends of each hanger bar 34 engages first and second mounting brackets and is suspended therebetween. Initially, a first hanger bar (e.g., 34a) may engage a first set of brackets while the second hanger bar (e.g., 34a) and connected shear bands are positioned about the drum. At this time, the second hanger bar may be disposed into the second set of brackets, which may entail stretching the springs 50 connecting the shear bands to the hanger bars. In this regard, the shear band may be tensioned about the outsider surface of the rotating drum. Though illustrated as having two shear bands connected to each hanger bar, it will be appreciated that each shear band may have its own hanger bar and that other attachment mechanisms may be utilized to attach and tension the shear bands. What is important is that one or both ends of the shear band is resiliently connected to the housing or frame while tensioned about an outside surface of the drum to allow the shear band to move relative to the drum during operation.

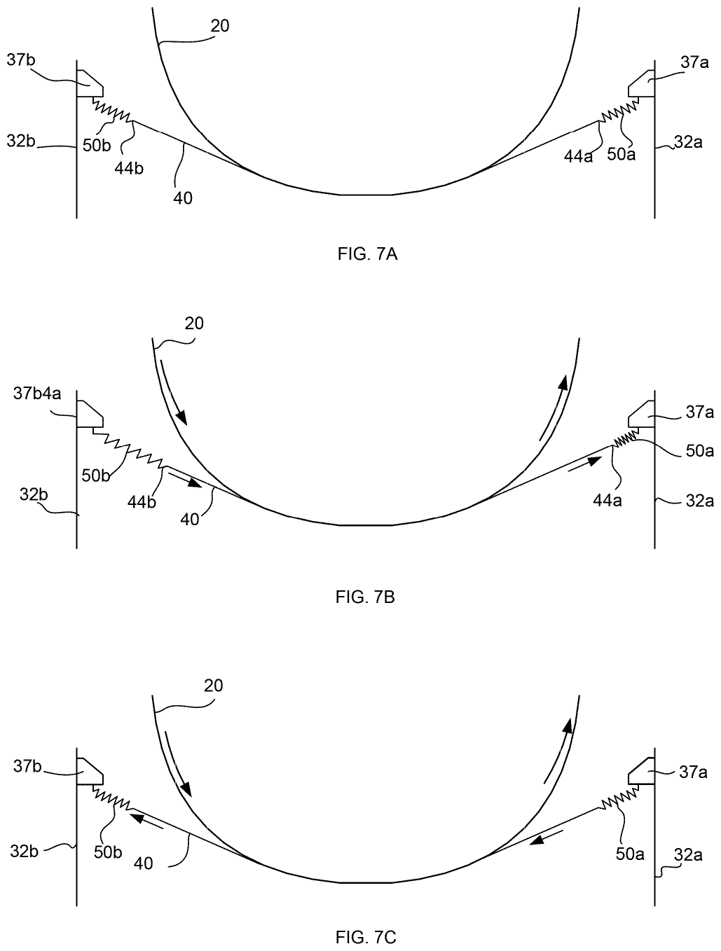

FIGS. 7A-7C illustrate movement of a shear band 40 relative to a rotating drum 20 where each end of the shear band 40 is resiliently connected (e.g., by one or more springs 50a, 50b) to the sidewalls 32a, 32b of a trimmer via first and second attachment blocks 37a, 37b. FIG. 7A illustrates a static position where each spring 50a, 50b is tensioned (e.g., partially stretched or deflected) to provide a desired tension between the ends 44a, 44b of the shear band 40 and about the outside surface of the drum. The number of springs, the spring constant of the springs and/or the deflection of the springs may be selected to provide a desired tension between the first and second ends of the shear band 40 thereby tensioning the band 40 about the outside surface of the drum. FIG. 7A represents a static position where the drum is not rotating. Once the drum 20 begins to rotate (e.g., counter-clockwise) as illustrated in FIG. 7B, friction between an outside surface of the drum 20 and the upper surface of the shear band 40 pulls the shear band 40 with the drum 20 stretching spring(s) 50b connecting one end 44b of the shear band 40 to the housing while the spring(s) 50a connecting the other end 44a of the shear band 40 to the housing contract. Due to the friction between the elements, the shear band 40 moves a short distance with the drum 20. Once deflected to a sufficient amount, energy stored in the stretched spring 50b overcomes the friction between the drum 20 and the shear band 40 pulling the shear band 40 back to or near its starting position. See. FIG. 7C. At this time, the stretching process repeats (e.g., FIG. 7B) until the springs return the shear band back to or near its starting position (e.g., FIG. 7C). Stated otherwise, the shear band oscillates or reciprocates between an extended or stretched position (e.g., FIG. 7B) and a retracted position (e.g., FIG. 7C). In this regard, a dynamic movement is imparted to the shear band 40 by the rotating drum 20.

When properly designed, the resilient connection of both ends of the shear band leads to a phenomenon called “stick-slip” movement. Under these conditions, the shear band 40 enters a state of alternative sticking and slipping over the drum 20. This oscillating or reciprocating motion of the shear band has proven to greatly increase the trimming efficiency. That is, the oscillating movement dramatically increases the number of effective cuts per unit of time (e.g., between the apertures in the shear band and slots in the drum), and may do so passively, without the need of a dedicated vibration motor or other dedicated actuator to actively drive the shear band. The movement of the shear band is passively induced by normal operation of the trimmer. Further, the movement of the shear band makes the shearing action more effective thereby improving plant trimming. The stick-slip motion may be further fine-tuned by adjusting parameters such as the stiffness of the springs or the friction between drum and shear band (achieved by the addition of lubricants, or by selecting specific materials for the different components). This arrangement may also eliminate the need for a separate shear band tensioning mechanism previously utilized with systems having stationary shear bands. Accordingly, this arrangement also avoids over tensioning problems, which are very common and can lead to failures in the motor, the bearings supporting the drum, or even the shear band itself.

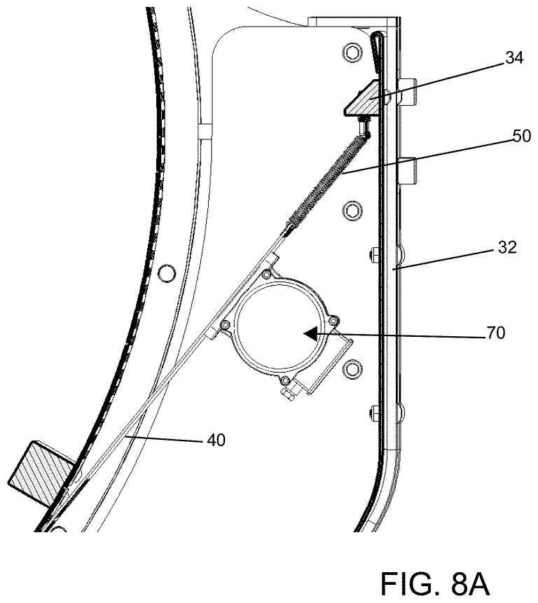

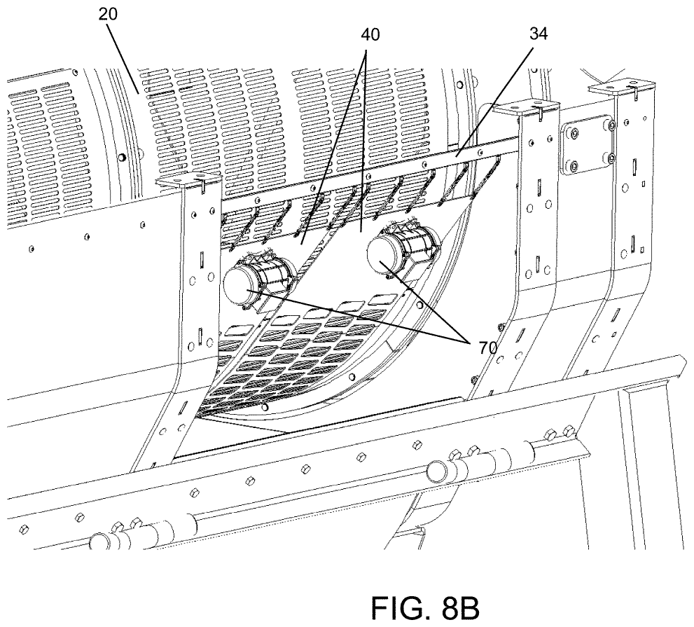

As discussed above, rotation of the drum may impart movement to the shear band without the use of a separate actuator or motor attached to the shear band. However, in various additional embodiments, an actuator or motor may be incorporated with the shear band to enhance or control the movement of the shear band. FIGS. 8A and 8B illustrate an embodiment of a shear band trimming system that is substantially similar to the system described above where both ends of the shear band 40 are resiliently connected to the housing. However, this embodiment of the shear band trimming system incorporates vibration motors 70 attached to each of the shear bands 40. The vibration motor 70 may be an eccentric rotating mass vibration motor (ERM) utilizing a small, unbalanced mass to create vibrations as it rotates. Alternatively, the vibration motor 70 may be a linear resonant actuator (LRA) containing an internal mass attached to a spring, which creates a force when driven. Other types of vibration motors may be used. As illustrated, the vibration motor 70 is attached to a lower surface of the shear band 40 between a point where the shear band connects to the resilient member 50 and the point where the shear band 40 contacts the rotary drum 20. When activated, the vibration motor 70 imparts movement to the shear band 40. Such movement may be in conjunction with any stick-slip movement imparted by rotation of the rotary drum 20.

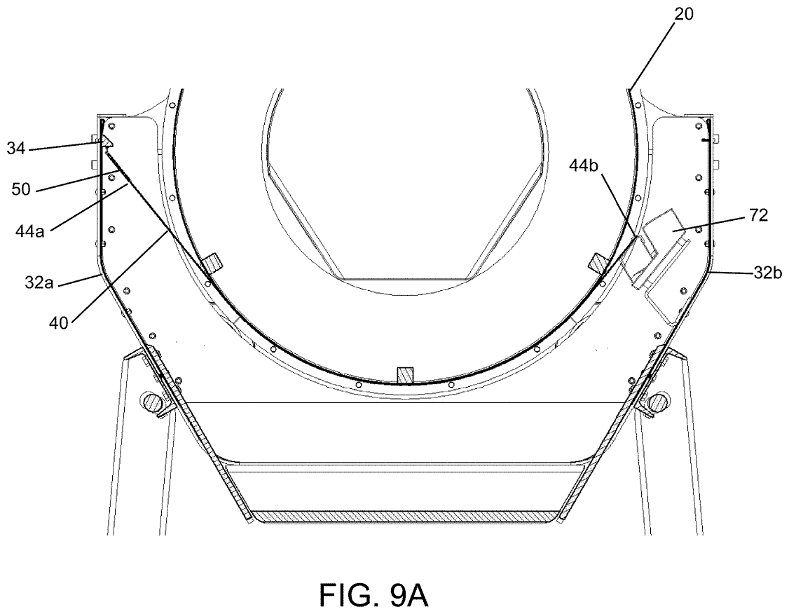

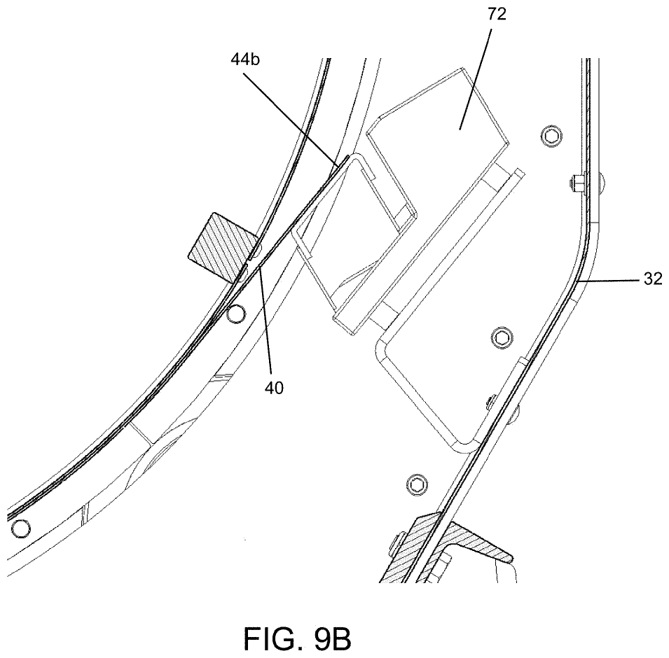

FIGS. 9A and 9B illustrate another embodiment of a shear band trimming system. This embodiment shares numerous components with the previously described systems and like reference numbers are utilized to refer to like components. As illustrated, the first end 44a of the shear band 40 connects to a spring 50, which connects to a first sidewall 32 of the housing via a connecting bracket 34. The second end 44b of the shear band 40 connects to a vibration motor 72 attached to the second sidewall 32b of the housing. In an embodiment, the vibration motor may be a linear actuator (e.g., LRA) that reciprocates back and forth when activated. When activated, the vibration motor 72 imparts movement to the shear band 40. Such movement may be in conjunction with any stick-slip movement imparted by rotation of the rotary drum 20.

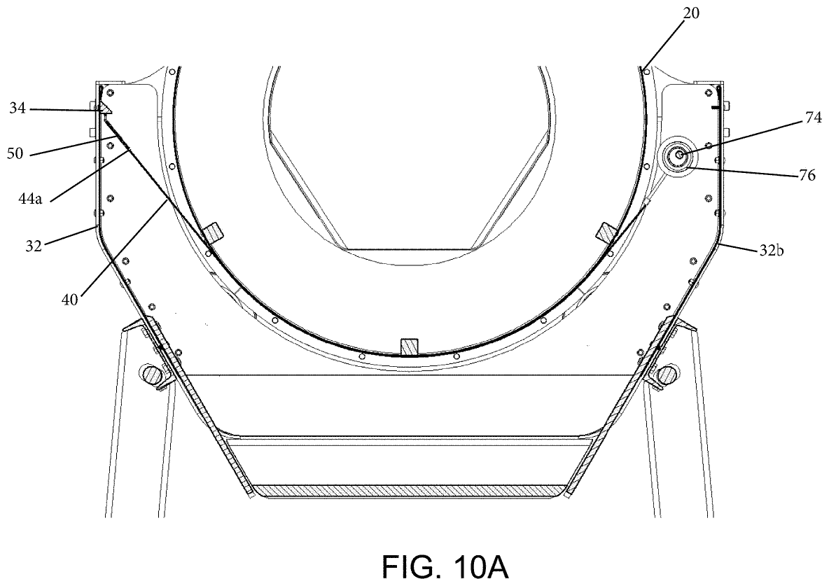

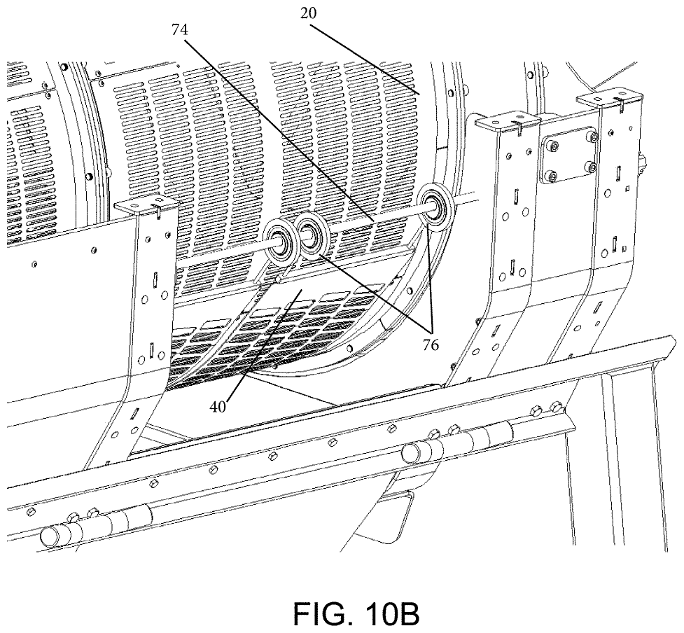

FIGS. 10A and 10B illustrate another embodiment of a shear band trimming system. This embodiment shares numerous components with the previously described systems and like reference numbers are utilized to refer to like components. As illustrated, the first end 44a of the shear band 40 connects to a spring 50, which connects to a first sidewall 32 of the housing via a connecting bracket 37. The second end 44b of the shear band 40 connects to a rotating shaft 74 via an offset or eccentric bearing 76. When the shaft 74 rotates, the eccentric bearing 76 rotates to produce a linear reciprocating motion to the attached end 44b of the shear band 40. This results in the spring 50 stretching and relaxing. That is, a reciprocating or oscillating motion is imparted to the shear band. In this embodiment, the shear band is primarily mechanically driven.

Other aspects and embodiments of the plant trimming apparatus comprise any one or more feature(s) disclosed herein in combination with any one or more other feature(s) or a variant or equivalent thereof. In any of the embodiments described herein, any one or more features may be omitted altogether or replaced or substituted by another feature disclosed herein or a variant or equivalent thereof. Numerous modifications and changes to the embodiments described above will be apparent to those skilled in the art.

What is claimed is:

1. A plant processing apparatus for trimming plant material, comprising:
a rotatable drum having an annular sidewall extending between first and second ends, the annular sidewall having a plurality of apertures extending through the sidewall between an inner surface and an outer surface;
a frame supporting the drum, wherein the rotatable drum is configured to rotate relative to the frame; and
at least one shear band disposed about a portion of the outside surface of the annular sidewall of the rotatable drum, the shear band having a first end resiliently connected to the frame, wherein the shear band is configured to move between a first position and a second position relative to the outside surface of the rotatable drum while the rotatable drum rotates relative to the shear band.

2. The apparatus of claim 1, wherein the shear band further comprises:
a second end resiliently connected to the frame, wherein rotation of the drum imparts movement of the shear band between the first position and the second position.

3. The apparatus of claim 1, further comprising:
at least one bias force element connecting the shear band to the frame, wherein the bias force element tensions the shear band about the outside surface of the annular sidewall of the rotatable drum.

4. The apparatus of claim 3, further comprising:
an adjustor disposed between the bias force element and the frame.

5. The apparatus of claim 1, further comprising:
an actuator disposed between a second end of the shear band and the frame, wherein the actuator is configured to move the shear band between the first position and the second position.

6. The apparatus of claim 1, further comprising:
a vibrator attached the shear band between the first end and a second end.

7. The apparatus of claim 1, further comprising:
a plurality of shear bands disposed along a length of the rotatable drum between the first and second ends, wherein each shear band is tensioned about a separate portion of the outside surface of the annular sidewall of the rotatable drum and each shear band has a first end resiliently connected to the frame.

8. The apparatus of claim 1, further comprising:
a rotary actuator configured to rotate the rotatable drum.

9. The apparatus of claim 1, wherein the shear band comprises:
a sheet material extending between the first end and a second end, wherein a plurality of apertures extend though the sheet material between an inner surface and an outer surface.

10. The apparatus of claim 9, wherein the plurality of apertures through the sheet material are larger than the plurality of apertures extending through the sidewall of the rotatable drum.

11. A plant processing apparatus for trimming plant material, comprising:
a housing;
a drum at least partially disposed within the housing and having a first end, a second end and an annular sidewall extending along a longitudinal axis between the first and second ends, the annular sidewall having a plurality of perforations extending through the annular sidewall;
a motor operably connected to the drum for imparting a rotation to the drum about the longitudinal axis;
a shear band disposed about a portion of an outside surface of the drum, the shear band having a plurality of plant trimming perforations; and
a first resilient member attaching a first end of the shear band to the housing;
a second resilient member attaching a second end of the shear band to the housing, wherein the first and second resilient members tension the shear band around the portion of the outside surface of the drum.

12. The apparatus of claim 11, wherein rotation of the drum about the longitudinal axis imparts a reciprocal movement to the shear band.

13. The apparatus of claim 11, wherein the resilient members comprise springs.

14. A method for operating a plant trimming device;
rotating a drum about a longitudinal axis, wherein the drum has a first end, a second end and an annular sidewall extending along the longitudinal axis between the first and second ends, the annular sidewall having a plurality of perforations extending through the annular sidewall;
tensioning a shear band about a portion of an outside surface of the drum, the shear band having a plurality of perforations; and
imparting an oscillatory movement to the shear band wherein the shear band moves a first distance partially around the drum in a direction of rotation of the drum and moves in a second distance partially around the drum in a direction opposite of the rotation of the drum.

15. The method of claim 14, wherein imparting the oscillatory movement comprises imparting a slip-stick movement to the shear band via rotation of the drum.

16. The method of claim 14, wherein imparting the oscillatory movement initially comprises:
stretching a first resilient member connecting a first end of the shear band to a support of the plant trimming device; and
contracting a second resilient member connecting a second end of the shear band to the support.

17. The method of claim 16, wherein imparting the oscillatory movement subsequently comprises:
contracting the first resilient member connecting the first end of the shear band to the support of the plant trimming device; and
stretching the second resilient member connecting the second end of the shear band to the support.

18. The method of claim 16, wherein the stretching is imparted by rotation of the drum and frictional contact between the drum and the shear band.

19. The method of claim 14, wherein imparting the oscillatory movement comprises:
applying a mechanical force to one end of the shear band while another end of the shear band is resiliently attached to the plant trimming device.

20. A plant processing apparatus for trimming plant material, comprising:
a housing;
a drum at least partially disposed within the housing and having a first end, a second end and an annular sidewall extending along a longitudinal axis between the first and second ends, the annular sidewall having a plurality of perforations extending through the annular sidewall;
a motor operably connected to the drum for imparting a rotation to the drum about the longitudinal axis;
a shear band disposed about a portion of an outside surface of the drum, the shear band having a plurality of apertures extending through it surface; and
a first resilient member attaching a first end of the shear band to the housing; and
an actuator connecting the second end of the shear band to the housing, wherein the shear band is tensioned around the portion of the outside surface of the drum and the actuator imparts a reciprocal movement to the shear band.

21. The apparatus of claim 20, wherein the actuator comprises one of
a rotary vibration motor; and
a linear vibration motor.
